(19) United States
(12) Patent Application Publication
(10) Pub. No.: US 2017/0287070 A1
(43) Pub. Date: Oct. 5, 2017

(54) SYSTEMS AND METHODS FOR PROVIDING A DYNAMIC ACCESS PAYMENT IN ASSOCIATION WITH A SECURITY

(71) Applicant: OTC MARKETS GROUP, INC., New York, NY (US)

(72) Inventors: R. Cromwell Coulson, New York, NY (US); Matthew Fuchs, Richond, WA (US); Sigurdur Petur Snorrason, Reykjavik (IS); Michael Modeski, Summit, NJ (US); Rahul Bose, New York, NY (US)

(73) Assignee: OTC MARKETS GROUP, INC., New York, NY (US)

(21) Appl. No.: 15/600,242

(22) Filed: May 19, 2017

Related U.S. Application Data
(63) Continuation of application No. 13/245,424, filed on Sep. 26, 2011.

(51) Int. Cl. G06Q 40/04

(52) U.S. Cl. CPC G06Q 40/04

(57) ABSTRACT

The disclosure describes systems and methods of utilizing an OTC trading system to convey and manage access fee and access rebate information. Specifically, the disclosure provides methods for providing an access payment in association with a security for display on a graphical user interface. The access payment is calculated using an access payment multiplier and quote price. The access payment multipliers can be applied either the Broker Dealer Level or the Quote Level. A Quote Level access payment multiplier is applied to a specific security wherein an access payment multiplier at the Broker Dealer Level is applied as a global default. Once an access payment for a security is calculated, the access payment is analyzed to determine whether it is in within the defined regulatory parameters. An access payment that is in within the parameters is provided for display while an access payment that is not is rejected.

### CROSS-REFERENCE TO RELATED APPLICATIONS

This application is a continuation application and claims priority to U.S. patent Publication Ser. No. 13/245,424, filed Sep. 26, 2011, and entitled “SYSTEMS AND METHODS FOR PROVIDING A DYNAMIC ACCESS PAYMENT IN ASSOCIATION WITH A SECURITY,” which application is incorporated herein by reference in its entirety.

### INTRODUCTION

Over the Counter (OTC), or off-exchange trading, allows two parties to trade securities directly from one party to the other party. In an OTC system, trading is carried out by broker-dealers operating as market makers, agency brokers and electronic communications networks (ECN) that make markets using inter-dealer quotation services. One such inter-dealer quotation service is OTC Link, operated by OTC Markets Group Inc. Under certain regulatory schemes, broker-dealers are allowed to charge access fees and/or pay access rebates for accessing their quotations. The access fees are charged in addition to the price of the security and, as a result, increase the overall cost of a trade. The access rebates are deducted from the price of the security and, as a result, decrease the overall cost of a trade. As a result of the cost increases and decreases, the amount charged as an access fee can be capped in accord with regulatory oversight.

### Systems and Methods for Providing a Dynamic Access Payment in Association with a Security

This disclosure provides systems and methods for providing a dynamic access fee and a dynamic access rebate in association with a security. Specifically, the present disclosure provides methods for providing a dynamic access fee and dynamic access rebate in association with a security for display on a graphical user interface.

In one embodiment, the present application describes a computer-implemented method for setting an access payment multiplier for a security. An access payment multiplier that is to be associated with a security is received. A determination is made as to whether the access payment multiplier is within a range associated with the security. Upon determining that the access payment multiplier is within the range, a numeric value associated with the access payment multiplier is identified. Using the identified numeric value, a rule for setting the access payment multiplier is identified. The access payment multiplier is then set in association with the security in association with the identified rule.

In another embodiment, the present application relates to a computer-implemented method for providing an access payment in association with a security. A request to trade a security is received and a determination is made whether an access payment multiplier has been waived. Upon determining that the access payment multiplier has not been waived, a quote price and an access payment multiplier associated with the security are identified. An access payment is then calculated based on the access payment multiplier and the quote price for the security. The access payment is then displayed in association with the trade for the security.

In yet another embodiment, the present application relates to a computer-implemented system for providing an access payment in association with a security. The system comprises a quote engine and a trade messaging engine. The quoting engine is communicatively coupled to a database for storing access payment multipliers. The trade messaging engine is configured to receive a request for a trade from an application and upon receipt of the request, calculate an access payment from an access payment multiplier and quote tick size or price associated with the security.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 is a diagram illustrating an embodiment of an exemplary computer system.

FIG. 2 is a block-diagram illustrating an embodiment of a quoting facility for associating an access payment with a quote price.

FIG. 3 is a method for setting an access payment multiplier.

FIG. 4 is a method for associating an access payment with a quote price.

FIG. 5 is a method for updating an executed trade.

FIG. 6 is an illustration of an embodiment of a graphical user interface displaying an access payment in association with a quote price.

FIG. 7 is an illustration of an embodiment of a graphical user interface for updating an access payment multiplier.

FIG. 8 is an illustration of an embodiment of a graphical user interface for adding an access payment multiplier.

### DETAILED DESCRIPTION

Although the techniques introduced above and discussed in detail below may be implemented for a variety of security trading systems, the present disclosure will discuss the implementation of these techniques for use in an OTC trading system. The reader will understand that the technology described in the context of an OTC trading system could be adapted for use with other security trading systems.

The disclosure describes systems and methods of utilizing an OTC trading system to convey and manage access fee and access rebate information at an individual Quote Level and global default Broker-Dealer Level. An access fee is a per share fee that a broker-dealer can charge other broker-dealers for trading with their displayed quotes. An access rebate is a per share payment that a broker-dealer can pay other broker-dealers for trading with their displayed quotes. Access fees and access rebates will be referred to collectively herein as access payments. Specifically, the disclosure provides methods for utilizing access payment multipliers to calculate an access payment that will be provided in association with a security for display on a graphical user interface.

Different access payment multipliers can be stored at the OTC trading system. These access payment multipliers can be set for either the Broker Dealer Level or the Quote Level. A Quote Level access payment multiplier is applied to a specific security wherein an access payment multiplier at the Broker Dealer Level is applied as a global default. When a security is associated with an access payment multiplier at the Quote Level, that access payment multiplier overrides the global default access payment multiplier at the Broker Dealer Level.

Furthermore, different access payment multipliers may be applied for a given quote depending on which side of the quote is accessed. A separate access payment multiplier may be set for the bid side of a quote and the ask side of a quote. In one embodiment, a broker-dealer accessing a quote for purchase is accessing the ask side of a quote. Therefore, separate access payment multipliers may be utilized for the same security.

Before calculating an access payment, an access payment multiplier is analyzed to determine whether it falls within a predefined range. In the embodiments defined herein, the predefined range corresponds to access payment parameters that comply with access payment regulations, although it will be understood that any range may be used as desired by the operator. The regulations currently employed by the Securities and Exchanges Commission can be found at http://www.sec.gov/rules/sro/finra/2010/34-62359. These regulations are subject to change and, to access the most recent regulations, one should contact the Securities and Exchanges Commission directly. Generally, the regulations define acceptable values for access fee payments. The present application utilizes a predefined range of access payment multipliers to calculate access payments within the acceptable range. In other words, access payment multipliers that fall within the predefined range will, when utilized, calculate access payments that are in compliance with current regulations. Access payment multipliers that are not within the predefined range will, when utilized, calculate access payments are outside the boundaries for regulatory compliance. Thus an access payment multiplier that is within the parameters is used to calculate an access payment. This access payment is then provided for display. An access payment multiplier that is not within the parameters is rejected.

The present disclosure also provides methods for updating an executed trade of a security, including an access payment related to an executed trade. When a request to update an executed trade is received, the counter-party in the trade is notified of the request. A determination is then made as to whether the counter-party has accepted the updated executed trade. If the updated executed trade has been accepted by the counter-party, the updated executed trade is distributed.

As such, the systems and methods of the present disclosure provide a trader with greater information about the overall price of a transaction. Furthermore, these systems and methods provide a trader with the ability to update an executed trade. These features provide an improved trading experience for broker-dealers using the OTC trading system.

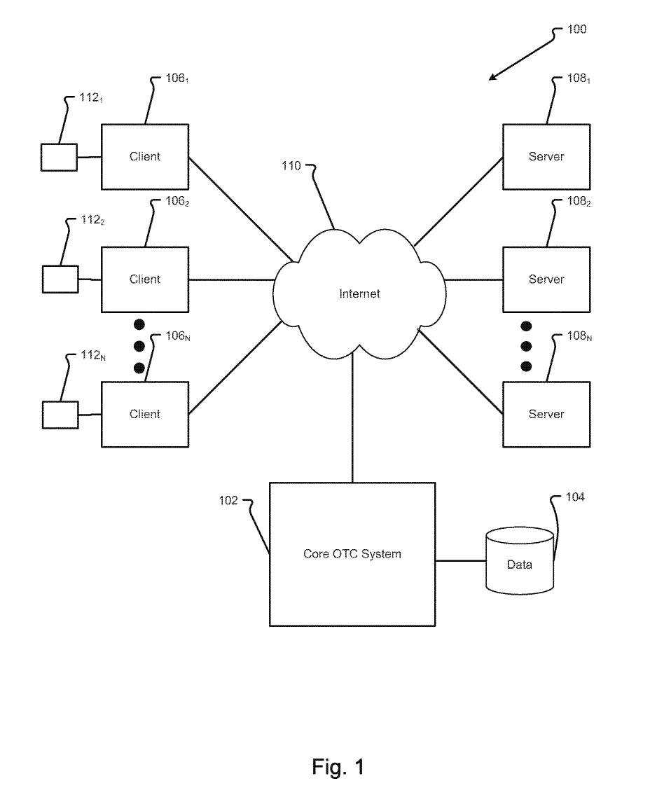

FIG. 1 is a diagram illustrating an embodiment of an exemplary computer system. FIG. 1 illustrates a general overview of a computer system and communication network 100 including a core OTC system 102, client devices 106₁ to 106_{N}, and remote servers 108₁ to 108_{N} according to an embodiment of the present invention. In computer network 100, clients 106₁ to 106_{N} are coupled through the Internet 110, or other communication network, to the core OTC system 102 and servers 108₁ to 108_{N}. While the core OTC system 102 is illustrated as a single entity, it is understood that the core OTC system 102 can comprise more than one server. A server can be used, either individually or in a distributed manner, and other servers providing additional functionality may also be interconnected to any component shown in network 100 either directly, over a LAN or a WAN, or over the Internet.

Several elements in the system shown in FIG. 1 are conventional, well-known elements that need not be explained in detail here. For example, each client device 106 could be a desktop personal computer, workstation, cellular telephone, personal digital assistant (PDA), laptop, or any other device capable of interfacing directly or indirectly with the Internet. Each client 106 may run a browsing program, such as Microsoft's Internet Explorer, or the like, or a microbrowser such as a WAP enabled browser in the case of a cell phone, PDA, tablet, or other handheld wireless devices, allowing a user of client 106 to browse pages and forms available to it from the core OTC system 102, servers 108₁ to 108_{N} or other servers over Internet 110. Alternatively, an application may be provided on each client for interfacing with the OTC system 102 depending on how the OTC system 102 is configured. Each client device 106 also may include one or more user interface devices 112, such as a keyboard, a mouse, touch screen, pen or the like, for interacting with a graphical user interface (GUI) provided by the browser on a monitor screen, LCD display, etc., in conjunction with pages and forms provided by the core OTC system 102, servers 108₁ to 108_{N} or other servers. The present technology is suitable for use with the Internet, which refers to a specific global Internetwork of networks. However, it should be understood that other networks can be used instead of the Internet, such as an intranet, an extranet, a virtual private network (VPN), a non-TCP/IP based network, any LAN or WAN or the like.

According to one embodiment as will be described in more detail below, the core OTC system 102 and any related components are operator configurable using an application including computer code-run using a central processing unit such as an Intel Pentium processor or the like. Computer executable instructions for operating and configuring the core OTC system 102 as described herein is preferably stored on a hard disk, but the entire program code, or portions thereof, may also be stored in any other memory device such as a ROM or RAM, or provided on any media capable of storing program code, such as a compact disk medium, a floppy disk, or the like. Additionally, the entire program code, or portions thereof, may be downloaded from a software source to core OTC system 102 over the Internet as is well known, or transmitted over any other conventional network connection as is well known, e.g., extranet, VPN, LAN, etc., using any communication medium and protocol as are well known. Additionally, portions of the program code may be downloaded or provided to client device 106 and executed on client device 106.

A database 104 is provided in FIG. 1. In the embodiment shown, the database 104 stores the data necessary to associate access payments with quote prices and other information necessary to the trader. The database 104 may also be used to store other information related to the OTC System and the transactions performed. Other architectures are also possible and any suitable computing architecture could be substituted without changing the functionality of the core OTC system 102.

In one embodiment, the database 104 stores all pertinent information for determining an access payment including: price, size, access payment amount, whether the access payment value was waived, the broker-dealer accessing a quote and the broker-deal posting the quote. When an access payment for a trade has not been waived, i.e. when an access rebate was provided or when an access fee was charged, the access payment amount is tallied for the respective broker dealer accessing the quote and the broker dealer posting the quote. This information regarding access payments may be aggregated over time and netted across all broker-dealer market participants. For example, a broker-dealer's access payments may be totaled across all counter-parties. The operator of the inter-dealer quotation service, such as OTC Markets Group, may collect from broker-dealers who owe fees on a net basis and pay broker-dealers who are owed rebates. Any invoices associated with the access fees or access payments may be totaled per a given period.

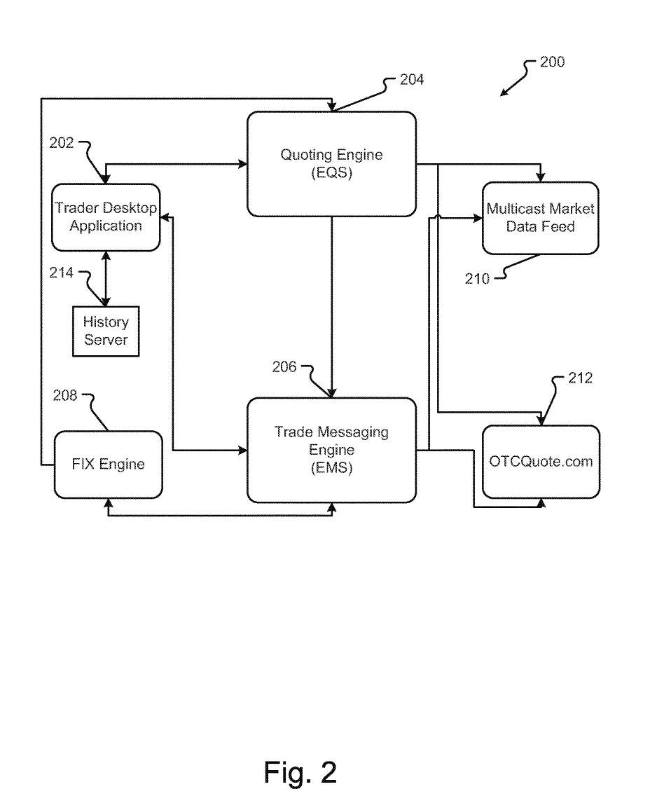

FIG. 2 is a block-diagram illustrating an embodiment of a core OTC system environment 200 for associating an access payment with a price quote.

The core OTC system environment may be comprised of one or more components. In the embodiment illustrated in FIG. 2, the core OTC system 200 includes the exemplary components include Trader Desktop Application 202, Quoting Engine (EQS) 204, Trade Messaging Engine (EMS) 206, FIX Engine 208, Multicast Market Data Feed 210, OTCQuote.com 212, and the History Server 214. While these components are illustrated separately, it will be appreciated that some or all may reside on the same device or be combined into one or more discreet subsystems. Furthermore, each component may be coupled to a server, database, or both.

The Trader Desktop Application 202 allows a trader to interact with the OTC market via an interactive means such as a web browser. An exemplary Trader Desktop Application 202 is the OTC Dealer operated by OTC Markets Group Inc. The Trader Desktop Application 202 may be communicatively coupled to a client device. Using the Trader Desktop Application 202, a trader can submit a quote for a security. Submitting a quote comprises inputting a price a trader is willing to buy or sell at and the number of shares the trader is interested in. The submitted quote is sent from the Trader Desktop Application 202 to the Quoting Engine (EQS) 204.

A broker-dealer can also associate an access payment multiplier, used to calculate an access payment, with their quote. An access payment is a per share fee or rebate that a broker-dealer the OTC system can charge other broker-dealers for trading with their quotes. The access payment multiplier is used to calculate the access payment. A broker-dealer accessing the quote may then either be charged an access fee or an access rebate calculated from the access payment multiplier. Calculating and applying access payment multipliers and access payments to a quote will be discussed in detail below. When a trader specifies or updates an access payment multiplier at the Trader Desktop Application 202, the access payment multiplier is submitted to the EQS 204. The access payment multipliers are either at the Broker Dealer Level or at the Quote Level. If provided on a Broker Dealer Level, the access payment multipliers perform as default access payment multipliers for all securities that the broker-dealer is responsible for. If provided on a Quote Level, the access payment multipliers are utilized for a specific security.

The Trader Desktop Application 202 may be further configured to provide a Quote Montage window to the trader. The Quote Montage window allows a trader to view the access payment multiplier. Display of access payment multipliers will be discussed in detail below. The Trader Desktop Application 202 may be further configured to provide an Update Quote window and an Add Quote window. The Update Quote window and the Add Quote window will be discussed in further detail below.

The Quoting Engine (EQS) 204 receives submitted quotes from the Trader Desktop Application 202. The EQS 204 also receives submitted quotes from the FIX Engine 208. An exemplary FIX engine 208 is OTC FIX, operated by OTC Markets Group Inc., is a software application that processes FIX messages between parties and/or applications. In one embodiment, a FIX message may include an ASK or a BID, as discussed in further detail below. Once a submitted quote is received at the EQS 204, the quote is published to the Trade Messaging Engine (EMS) 206, Multicast Market Data Feed 210, and to an OTC quote website, such as OTCQuote.com 212. Once the quote is published, the quote publication will appear on markets data distribution systems and securities websites such as Bloomberg, Reuters, and the OTC Markets website. As will be appreciated by one in the art, the quote may be published to other entities and/or components and via other communications mechanisms as is necessary to enact the publication.

The EQS 204 may be further configured to receive and store access payment multipliers at both the Broker Dealer Level and at the Quote Level. As will be discussed in further detail below, a broker-dealer can specify a set of global access payment multipliers at the Broker Dealer Level that will be used as default multipliers. This default access payment multiplier may be overridden for a security if that security is associated with an access payment multiplier at the Quote Level. In this instance, an access payment multiplier at the Quote Level will be applied to a security instead of applying an access payment multiplier set at the Broker Dealer Level.

In practice, when a new or updated access payment multiplier is received, the EQS 204 first validates that the access payment multiplier is within an acceptable range. In this embodiment, the acceptable range corresponds to regulatory parameters. The access payment multiplier includes a numeric value. Access payment multipliers with numeric values within the acceptable range will, when utilized, calculate an access payment in compliance with regulatory oversight. In one embodiment, the numeric value included in the access payment multiplier must be a whole number between (inclusive) −30 and +30. Negative numbers represent fees charged to broker-dealers accessing the respective quotation while positive number represent rebates that will be made to broker-dealers accessing a quotation. The EQS 204 will reject an access payment multiplier not within the specified range as that access payment multiplier will calculate an access payment outside the acceptable regulatory range.

The EQS 204 then sets the access payment multiplier based on the associated numeric value. As discussed above, the access payment multiplier may be different depending on whether the bid side or the ask side is accessed. Moreover, the process of setting an access payment multiplier may be slightly different depending on whether the access payment multiplier is new or is an update. If the access payment multiplier is new, the EQS 204 determines whether numeric value is within the −30 to +30 range. If the numeric value is within this range, the EQS 204 sets the specified numeric value as the access payment multiplier at the Quote Level. Until this is changed, access payments for this security will be calculated using the specified numeric value at the Quote Level. If the numeric value is unspecified or set to default, the default value at the Broker Dealer Level will be used as the access payment multiplier for that security. Until this is changed, access payments for this security will be calculated using the default access payment multiplier value at the Broker Dealer Level.

If the access payment multiplier is an update, the EQS 204 determines the numeric value associated with the access payment multiplier. If the numeric value is between −30 and +30, inclusive, the access payment multiplier will be set to the specified numeric value at the Quote Level. This value will replace any previously cached access payment multiplier values for the security. Until this is changed, access payments for this security will be calculated using the updated specified numeric value at the Quote Level. If the numeric value is unspecified the previous access payment multiplier, stored in cache, will be applied to the security. This previous access payment multiplier may be either the default value at the Broker Dealer Level or a previously specified value at the Quote Level. If the numeric value is set to default, the default value at the Broker Dealer Level will be used at the access payment multiplier for that security. Until this is changed, access payments for this security will be calculated using the default access payment multiplier value at the Broker Dealer Level. When an access payment multiplier is updated or added, the EQS 204 stores the new value in cache.

In one embodiment, the EQS 204 can be further configured to store an indication that access payment multipliers should be disabled for a particular broker-dealer. In another embodiment, the poster of a quote may also chose to waive the access payment at the time of execution or countering. Waiver of an access payment may occur on an execution-by-execution basis. In another embodiment, waiver of an access payment may only be permitted if the access payment multiplier is negative, representing a fee, and not positive to indicate a rebate.

The Trade Messaging Engine (EMS) 206 is configured to receive quote information from the EQS 204. The EMS 206 is also configured to receive a request for trade execution from the Trader Desktop Application 202. An execution is an agreement between broker-dealers sending and receiving the trade messages to purchase or sell a security. Upon receipt of the request for execution, that is, when a purchaser indicates a wish to purchase some or all of the securities offered in a quote, the EMS 206 calculates an access payment for the security using the stored access payment multiplier.

In one embodiment, the EMS 206 calculates an access payment by, first, determining whether the access payment has been waived by the poster of the quote or disabled for the particular broker-dealer. In one embodiment a waive flag may be set and stored at EMS 206. If the access payment has been waived or disabled, for this execution, the calculations stop and an access payment is not attached to quote price.

On the other hand, if the access payment has not been waived or disabled, the EMS 206 determines whether the bid side or the ask side is accessed. This determination will control whether a “bid” access payment multiplier or the “ask” access payment multiplier is utilized for a given security. In one embodiment, a broker-dealer accessing a quote for purchase is accessing the bid side of a quote and the bid access payment multiplier should be used for that quote. The bid access payment multiplier may be either an access fee or an access rebate. A broker-dealer accessing a quote by posting the quote is accessing the ask side of a quote and the ask access payment multiplier should be used for that quote. The ask access payment multiplier may be either an access fee or an access rebate.

Once the EMS 206 has determined which access payment multiplier should be used, the EMS 206 calculates an access payment per share of a security. This calculation is based on the access payment multiplier and the quote price. The access payment multipliers will be applied differently depending on the price of the quotation. For quotations with a price greater than $1, the access payment multiplier represents the percentage of the quote tick size of 0.01. For quotations with a price less than $1 and greater than $0.01, the access payment multiplier represents the percentage of the quote tick size of 0.0001. For quotations with a price less than $0.01, the access payment multiplier represents the number divided by 10000 and multiplied by the quote price. In sum, the following equations may be utilized to calculate an appropriate access payment per share for a security:

For quote tick sizes greater than $1:

[(access payment multiplier)/100]*0.01

For quote tick sizes less than $1 but greater than $0.01:

[(access payment multiplier)/100]*0.0001

For quote tick sizes less than $0.01:

[(access payment multiplier)/100]*0.01*quote price

As will be understood by one skilled in the art, these equations are for exemplary purposes only. Any ratio and range for calculating an appropriate access payment per share for a security may be utilized within the scope of the present disclosure.

The EMS 206 may then calculate an access payment for the entire execution order. This may entail multiplying the access payment per share by the total number of ordered shares for that security. In one embodiment, this value may be rounded down to two decimal places. This value represents the dollar amount of access payment that should be collected from or rebated to broker-dealer order initiator.

The EMS 206 is further configured to communicate the request for execution the FIX Engine 208. The Fix Engine 208 is used to communicate with third party vendors and broker-dealers (not illustrated). The FIX Engine 208 may be configured as an interface to both notify and receive notification from third party vendors and broker-dealers of an updated execution. The FIX Engine 208 is communicatively coupled to the EMS 206, which can relay notifications to the Trader Desktop Application 202.

The History Server 214 is communicatively coupled to Trader Desktop Application 202. The History Server 214 stores information about previous executions. This information may include access payment adjusted prices on past executions. The History Server 214 can be accessed by the Trader Desktop Application 202 to provide the previous executions for display using the Trader Desktop Application 202. The History Server 214 may be further configured to provide a template to the Trader Desktop Application 202 for searching and handling alterations and cancellations. This template may be displayed in a miniature browser of the Trader Desktop Application 202. In one embodiment, the History Server 214 may also be configured to alter the visual appearance of the template so the trader perceives it the template as originating from Trader Desktop Application 202. In another embodiment, the History Server 214 may provide the template in a History Server 214 browser separate from the Trader Desktop Application 202. In another embodiment, an administrator would have the ability to alter or cancel execution upon receipt of verbal or written agreement from both parties.

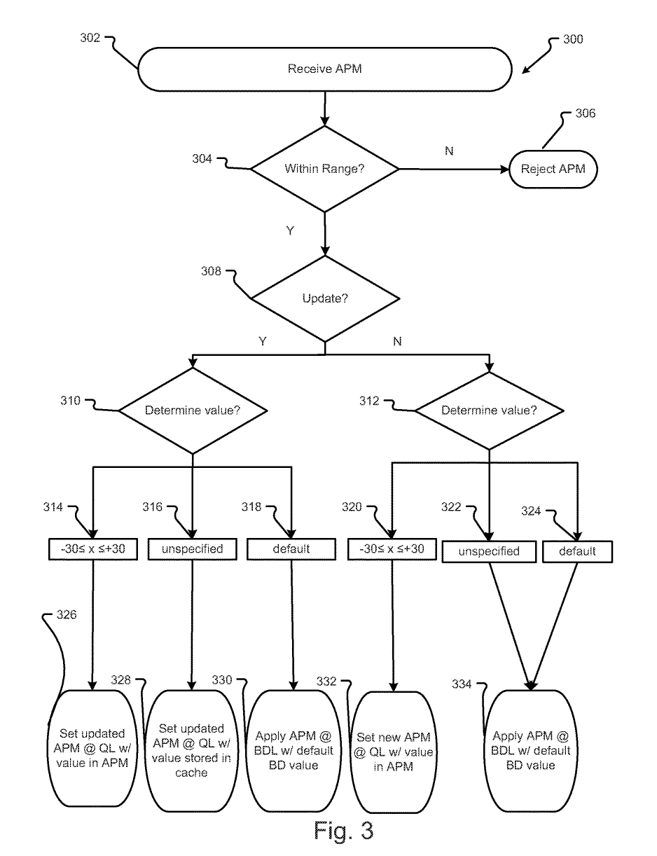

FIG. 3 is an illustration of an exemplary method 300 of setting an access payment multiplier. As discussed above, an access payment multiplier is either an access fee or access rebate applied to a security. The access payment multiplier can be default global value set by the broker-dealer. For the purposes of this application, such a default value will be referred to as an access payment multiplier at the Broker Dealer Level. The Broker Dealer Level access payment multiplier is the default access payment multiplier applied to all securities quoted by that broker-dealer. Alternatively, a broker-dealer can set a different access payment multiplier for a particular security. Such an access payment multiplier will be referred to as an access payment multiplier at the Quote Level. When a security is associated with an access payment multiplier at the Quote Level, the value of the Quote Level access payment multiplier will be used in lieu of the value of the Broker Dealer Level access payment multiplier. The specified Quote Level access payment multipliers may be changed, over time, by the broker-dealer. For example, a broker-dealer may decide that the value of the Quote Level access payment multiplier associated with a security is too low or too high. On the other hand, a broker-dealer may decide that the security should no longer be associated with a specified access payment multiplier and may reassign the security to the default value access payment multiplier at the Broker Dealer Level. The method outlined in FIG. 3 details embodiments of the logic utilized to set and change the access payment multipliers for a given security.

At operation 302, an access payment multiplier is received. The access payment multiplier may be received from a broker-dealer, as part of, or separately from, a request for a trade. The access payment multiplier includes a numeric value as well as indication of whether the access payment multiplier should be set as on the ask side or on the bid side for a quote. Once an access payment multiplier is received, flow proceeds to operation 304.

At operation 304, a determination is made as to whether the numeric value included in the access payment multiplier is within an acceptable range. In one embodiment, the numeric value must be a whole number between +30 and −30, inclusive. Negative values between 0 and −30 may represent access fees. Access fees are charged to broker-dealers accessing the quotation. Positive values may represent access rebates. Access rebates are payments that will be made to broker-dealers accessing the quotation. As described above, the EQS may determine whether the numeric value included in the access payment multiplier is within an acceptable range. If the access payment multiplier is not in the acceptable range, flow proceeds to operation 306. If the access payment multiplier is in the acceptable range, flow proceeds to operation 308.

At operation 306, the access payment multiplier is rejected. In one embodiment, the broker-dealer submitting the access payment multiplier may be notified that it was not within an acceptable range. In another embodiment, an acceptable numeric value may be suggested to the broker-dealer. In yet another embodiment, the broker-dealer may be provided with another opportunity to submit an appropriate numeric value, at which point flow proceeds back to operation 302.

At operation 308, a determination is made as to whether the access payment multiplier is an update. An access payment multiplier may be an update when an access payment multiplier has been previously set at the Quote Level. Alternatively, an access payment multiplier may be new when an access payment multiplier has not been previously set at the Quote Level. In one embodiment, the EQS reviews the information included in the access payment multiplier. If the access payment multiplier indicates that it should be set as an update, flow proceeds to operation 310. If the access payment multiplier indicates that it should be set as new, flow proceeds to operation 312.

At operation 310, the numeric value associated with the updated access payment multiplier is determined. One of three results may be reached from this determination. First, a determination may be made that the access payment multiplier has a numeric value between −30 and +30, inclusive. In this case, flow proceeds to result 314. Second, a determination may be made that the access payment multiplier is unspecified. In this case, flow proceeds to result 316. Third, a determination may be made that the access payment multiplier is set to default. In this case, flow proceeds to result 318.

From result 314, the access payment multiplier at the Quote Level is set to the numeric value associated with the updated access payment multiplier at operation 326. For example, the updated access payment multiplier may be associated with a numeric value of +26 and the previously stored value for the access payment multiplier may be +23. Since the access payment multiplier is an update within the acceptable range, the access payment multiplier at the Quote Level will be updated from +23 to +26. This updated value is stored in cache. Flow is then terminated.

From result 316, the access payment multiplier at the Quote Level is set to the numeric value previously stored in cache at operation 328. For example, if the access payment multiplier was not associated with a numeric value, a value stored in cache may be utilized. This value could be either a specified Quote Level numeric value or could be the default Broker Dealer Level numeric value. Flow is then terminated

From result 318, the default access payment multiplier value at the Broker DealerLevel is applied at operation 328. As discussed above, this value is set by the broker-dealer and is used for securities quoted by the broker-dealer for which an access payment multiplier is not specified at the Quote Level. Flow is then terminated

At operation 312, the numeric value associated with the new access payment multiplier is determined. One of three results may be reached from this determination. First, a determination may be made that the access payment multiplier has a numeric value between −30 and +30, inclusive. In this case, flow proceeds to result 320. Second, a determination may be made that the access payment multiplier is unspecified. In this case, flow proceeds to result 322. Third, a determination may be made that the access payment multiplier is set to default. In this case, flow proceeds to result 324.

From result 320, the access payment multiplier at the Quote Level is set to the numeric value associated with the new access payment multiplier at operation 332. For example, if the access payment multiplier is associated with a numeric value of +26, the access payment multiplier at the Quote Level will be set to +26. Therefore, until the access payment multiplier is changed, the security will be associated with the access payment multiplier at the Quote Level and will not be assigned the default Broker Dealer Level access payment multiplier. This new access payment multiplier value is stored in cache. Flow is then terminated.

From result 322, the default access payment multiplier value at the Broker Dealer Level is applied at operation 334. As discussed above, this value is set by the broker-dealer and is used for securities quoted by the broker-dealer for which an access payment multiplier is not specified at the Quote Level. Flow is then terminated

From result 324, the default access payment multiplier value at the Broker Dealer Level is applied at operation 334. As discussed above, this value is set by the broker-dealer and is used for securities quoted by the broker-dealer for which an access payment multiplier is not specified at the Quote Level. Flow is then terminated

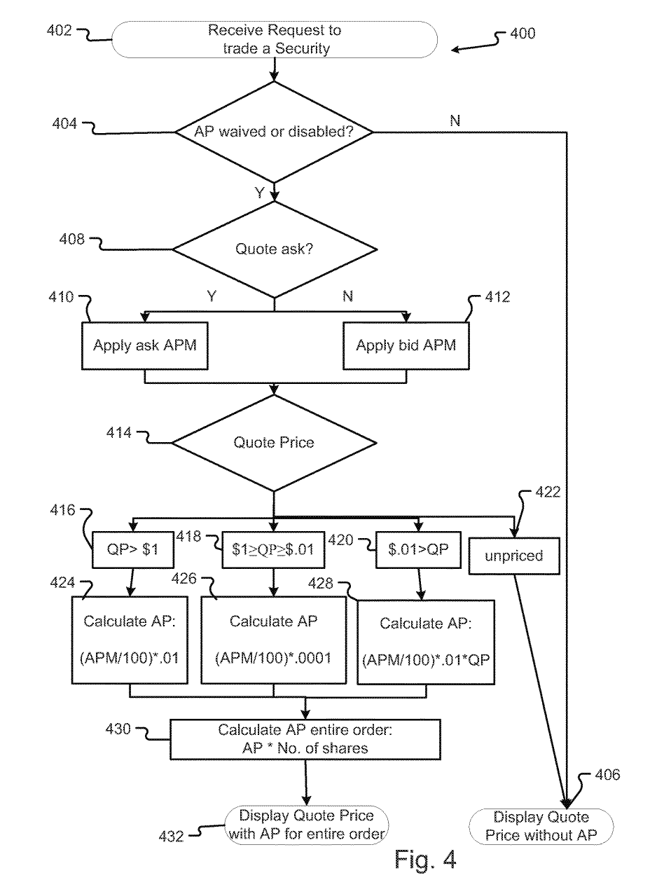

FIG. 4 is an illustration of an exemplary method 400 for displaying an access payment in association with a security using access payment multipliers.

At operation 402, a request is received to trade a security. As discussed above, a security is sold by a particular broker-dealer, or, in other words, broker-dealer. The broker-dealer allows traders to buy and sell securities by submitting quotes to a marketplace such as OTC Markets Group. A trader can access the marketplace and request to trade a security. As discussed with regard to FIG. 2, the request trade a security is received at a Trader Desktop Application and may be forwarded to the EMS. Flow then proceeds to operation 404.

At operation 404, a determination is made whether there is an access payment associated with the security or whether the access payment have been waived or disabled. The poster of a quote may also chose to waive the access payment at the time of execution or countering. Waiver of an access payment may occur on an execution-by-execution basis. In another embodiment, the waiver applies to all trades for a particular security. In yet another embodiment, this waiver may apply to all securities quoted by that broker-dealer. In one embodiment, an access payment may only be permitted if the access payment multiplier is negative, representing a fee, and is not positive to indicate a rebate. In addition, access payment multipliers may be disabled for a broker-dealer. If the access payment is waived or disabled, no access payment is calculated and flow proceeds to operation 406. If an access payment has not been waived or disabled, the access payment multiplier is communicated to EMS and flow proceeds to operation 408.

At operation 406, the quote price for the security is displayed without an access payment. In one embodiment, the quote price is displayed on a graphical user interface, such as graphical user interface 500. When the quote price is displayed without an access payment, the value in the access payment column is empty for that particular quote. In another embodiment, an icon is displayed conveying to the trader that there is no access payment associated with that security. As can be appreciated by one skilled in the art, any manner of conveying that there is not an access payment associated with the security is contemplated within the scope of the present application.

When the EQS determines that there are access payment multipliers associated with the broker-dealer, operation 408, determines whether the bid side or the ask side is accessed. Different access payment multipliers can be set for the same security depending on whether the bid side or the ask side is accessed. Therefore, a determination must be made to determine which side of a quote is being accessed to establish the appropriate access payment multiplier. If the ask side is being accessed, flow proceeds to operation 410. If the bid side is being accessed, flow proceeds to operation 412.

At operation 410, the ask access payment multiplier for the security is applied. Flow then proceeds to operation 414.

At operation 412, the bid access payment multiplier for the security is applied. Flow then proceeds to operation 414.

At operation 414, the quote price is determined. One of four results may be reached from this determination. First, a determination may be made that the quote price is greater than one dollar. In this case, flow proceeds to result 416. Second, a determination may be made that the quote price is between $1 and $0.01, inclusive. In this case, flow proceeds to result 418. Third, a determination may be made that the quote price is less than $01. In this case, flow proceeds to result 420. Fourth, a determination may be made that the quote is unpriced. In this case, flow proceeds to result 422.

From result 422, no access payment is calculated because an access payment multiplier cannot be used to calculate an access payment for an unpriced quote. Flow then proceeds to operation 406 where the quote price is displayed without an access payment.

In another embodiment, an access fee may be calculated when a quote in unpriced based on an executed price negotiated between broker-dealers. In this embodiment, when the price is negotiated, flow proceeds back to operation 414 wherein the quote price is determined.

From result 416, an access payment is calculated on a per share basis at operation 424. Since the quote price is greater than $1, the following equation is used to calculate the access payment: [(access payment multiplier)/100]*0.01. Flow then proceeds to operation 430.

From result operation 418, an access payment is calculated on a per share basis at operation 426. Since the quote price is between $1 and $0.01, inclusive, the following equation is used to calculate the access payment: [(access payment multiplier)/100)] *0.0001. Flow then proceeds to operation 430.

From result operation 420, an access payment is calculated on a per share basis at operation 428. Since the quote price is less than $0.01, the following equation is used to calculate the access payment: [(access payment multiplier/100] *0.01*quote price. Flow then proceeds to operation 430.

At operation 430, the access payment for the entire order is calculated. In one embodiment, this calculation comprises multiplying the access payment calculated in either operation 424, 426, or 428 by the total number of shares in an order. In one embodiment, this value may be rounded down to two decimal places. This value represents the dollar amount of access payment that should be collected from or rebated to broker-dealer order initiator. Once the access payment for the entire order is calculated, flow proceeds to operation 430.

At operation 432, the access payment for the entire order is displayed in association with the quote price. In one embodiment, the quote price and access payment are displayed on a graphical user interface as part of a book of quotes, such as graphical user interface 500. An exemplary window of a graphical user interface is the Quote Montage window 502 operated by OTC Markets Group Inc. As will be appreciated by one skilled in the art, any manner of display and association can be used to display the access payment with the associated quote price. In one embodiment, an icon is displayed next to the security indicating that the overall cost of the security will include an access payment. In one embodiment, the access payment is not shown in a Quote Montage 502 window but information is available in a tool tip when hovering the mouse over the quote. In another embodiment, the access payment can also be displayed in a Trader Information dialog box accessible from the Quote Montage window 502 in the graphical user interface. If the latter option is selected, the Trader Desktop application 202 will subtract or add the access payment from the quote price when ranking the quote in the Quote Montage window. As a result, the net execution price is shown at the top of the Quote Montage window 502. Once the access payment is displayed, flow is terminated.

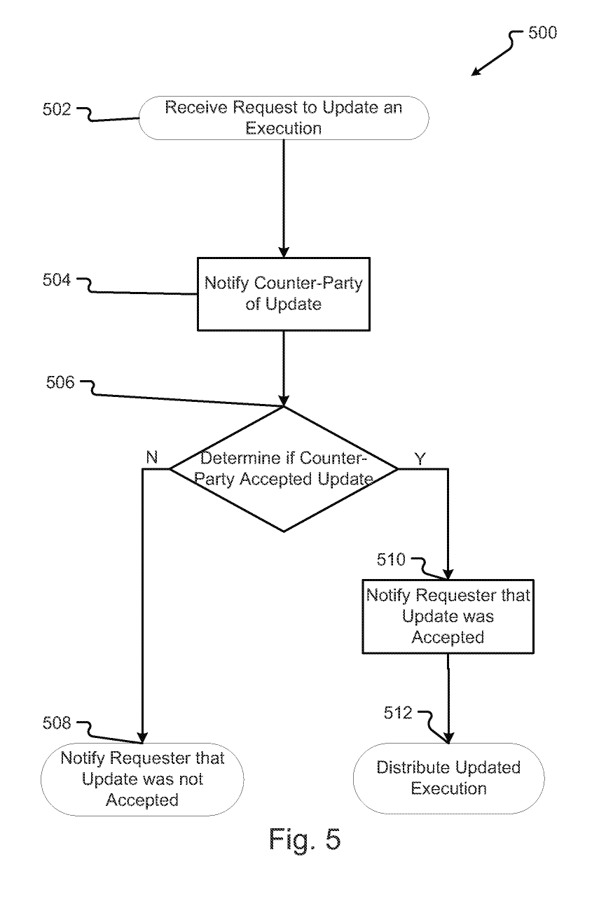

FIG. 5 illustrates an exemplary method 500 for updating an executed trade. The trades discussed with reference to FIG. 5 are executed and, therefore, have already been completed.

At operation 502, a request to update an executed trade is received. As discussed with reference to FIG. 2, an executed trade is a completed purchase or sale of a security. Exemplary requests to update an executed trade may include a request to alter an executed trade, such as changing the numbers of securities purchased, or a request to cancel an executed trade, such as canceling the agreement between two broker-dealers. As may be appreciated by one skilled in the art, any number of different updates may be requested. The request to update an executed trade is implemented by an interface of the EMS. In one embodiment, the interface may be accessed by the FIX Engine and the History Server. In another embodiment, the interface may be accessed through the Trader Desktop Application. In yet another embodiment the interface may be accessed through the Trader Desktop Application coupled with the History Server. Once a request to update a trade is received, flow proceeds to operation 504.

At operation 504, the counter-party of an executed trade is notified of the request to update the executed trade. When a purchaser of a security is the requestor, the seller of the security is notified of the request to update. When the seller of security is the requestor, the purchaser of the security is notified of the request to update. A notification may comprise any means of notifying known in the art, including but not limited to an alert, an email notification, a text message, an acceptance dialog box etc. Once the counter-party of the executed trade is notified of the request to update, flow proceeds to operation 506.

At operation 506, a determination is made whether the counter-party accepted the updated executed trade. In one embodiment, such a determination is made by ascertaining whether an acceptance of the update was received by the interface. An acceptance may comprise any manner of accepting an action known in the art, including but not limited to selecting an accept button in a dialog box, text message, alert, etc In addition, inaction may be deemed as acceptance in some embodiments. Furthermore, a determination of non-acceptance may be made by ascertaining whether the update was not accepted. Like an acceptance, a non-acceptance may also include any manner of non-acceptance known in the art, including but not limited to selecting a non-accept button in a dialog box, text message, alert etc. If a determination is made that the counter-party did not accept the update, flow proceeds to operation 508. If a determination is made that the counter-party did accept the update, flow proceeds to operation 510.

At operation 508, the requestor is notified that the counter-party did not accept the update. As may be appreciated by one skilled in the art, a notification may comprise any means of notifying known in the art, including but not limited to an alert, an email notification, a text message, an acceptance dialog box etc.

At operation 510, the requestor is notified that the update was accepted. As may be appreciated by one skilled in the art, a notification may comprise any means of notifying known in the art, including but not limited to an alert, an email notification, a text message, an acceptance dialog box etc.

At operation 512, an updated execution is distributed. When the updated execution is distributed, the updated execution may be broadcast to OTC exchange websites. The updated execution may also be communicated to a data feed for trading securities.

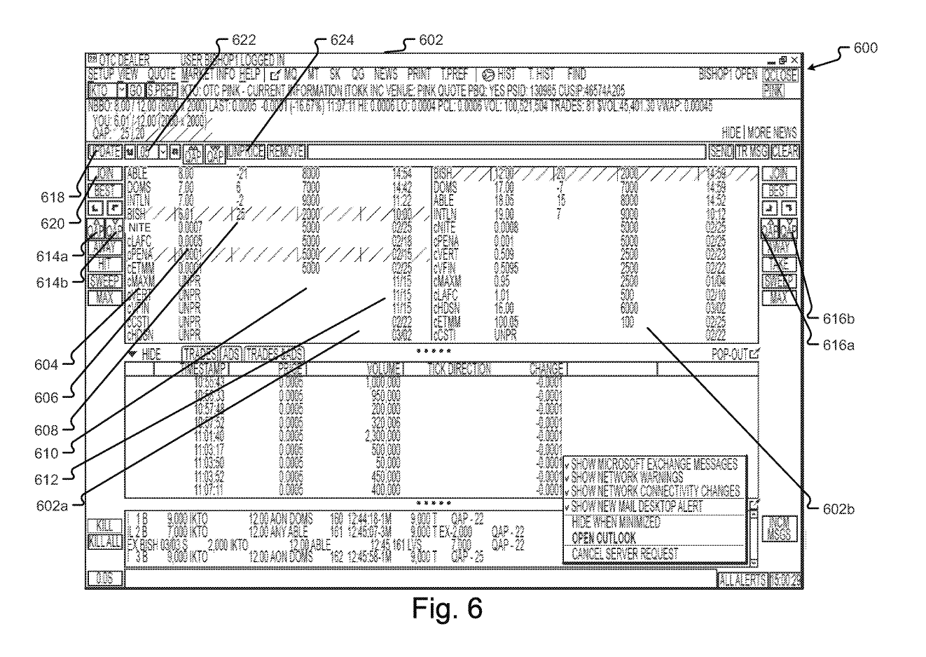

FIG. 6 illustrates an exemplary graphical user interface 600 for displaying access payments in association with a quote.

Graphical user interface may be accessed via any suitable means, for example via a user interface on a trader desktop application. As illustrated, graphical user interface 600 may provide one or more windows for display and one or more elements for selection and/or input. Windows may include one or more elements and, additionally, may provide graphical display areas, instructions, windows, or other useful information to the user. Elements may be displayed as buttons, tabs, icons, toggles, or any other suitable visual access element, etc., including any suitable element for input selection or control.

According to one embodiment, as displayed in FIG. 6, the graphical user interface 600 may include a Quote Montage window 602 for displaying securities by name 604, quote price 606 and, if applicable, associated access payment 608. In one embodiment, Trader Desktop Application sorts the securities listed in the quote montage to aid the trader in security selection.

As illustrated in graphical user interface 600, information for a security is displayed in a single row in the Quote Montage window 602. The Quote Montage window 602, may be divided into sub windows. For example, the left hand side of Quote Montage window 602 may display “bids” in sub window 602a. The right hand side of Quote Montage window 602, may displays “asks” in sub window 602b. In one embodiment, the broker name 604 is displayed in the leftmost column of the row. The name of the broker for the security is represented by an abbreviation. In one embodiment, the quote price 606 associated with the security is displayed in the second column from the left in the Quote Montage window 602. The access payment 608 is displayed in the column next to the quote price 606 column. As discussed above, a positive access payment represents an access rebate and a negative access payment represents an access fee. A column with the size of shares 610 is displayed in the column next to the access payment 608, and the time of update 612 is displayed in the column next to the size of share 610. A user may select a particular quote by accessing any part of the row associated with the quote. For example, a user may click on any of quote name 604, quote price 606, access payment 608, size of share 610, and time of update 612. In another embodiment, a user may hover the mouse over any of these elements to select a particular quote.

In another embodiment, the Quote Montage window 602 may not display a quote price. In this embodiment, a broker-dealer would provide an execution based on the best price in a reference market. In another embodiment, the Quote Montage window 602 may display neither a quote price nor a size of shares. In this embodiment, the broker-dealer would provide an execution based on the best price in a reference market.

As exemplified in quote montage window 602, certain securities may be associated with an access fee, other securities may be associated with an access rebate, while other securities may not be associated with any access payment at all. For example, the ABLE security is associated with an access fee of −21. Alternatively, the DOMS security is associated with an access rebate of 6. The NITE security, however, is not associated with any access payment, and therefore no value is included in the access payment column. As discussed above, certain securities may not be associated with an access payment if the broker-dealer responsible for that security has not set an access payment. Alternatively, a security may not be associated with an access payment if access payments have been disabled for the broker-dealer who controls the security.

In addition, Quote Montage window 602 may also include an unprice button 624. By selecting the unprice button 624, a broker-dealer is choosing to unprice a quote. When a quote is unpriced, any access payment multipliers associated with the quote will no longer be displayed in Quote Montage window 602.

In addition, Quote Montage window 602 may include one more access payment update buttons 614a and 614b and 616a and 616b. Access payment update buttons 614a and 614b are associated with the bid side of a quote while access payment update buttons 616a and 616b are associated with the ask side of a quote. The access payment update buttons 614a and 614b and 616a and 616b may change appearance depending on the access payment value of the quote selected in the Quote Montage window 502. In one embodiment, if the user does not have a quote for the security, the access payment update buttons 614a and 614b and 616a and 616b may have black arrows and the functionality may be disabled. If the access payment value for the selected quote is positive, indicating a rebate, the access payment update buttons 614a and 614b and 616a and 616b may have green arrows. If the access payment value for the quote is negative, indicating a fee, the access payment update buttons 614a and 614b and 616a and 616b may have red arrows. When the access payment update buttons 614a and 614b and 616a and 616b are activated, in other words when the arrows on the buttons are colored green or red, the user may utilize the access payment update buttons to increase or decrease the access payment multipliers associated with the selected security. The increased or decreased access payment multiplier will be displayed in update display box 622.

For example, a user may click the “up” access payment update buttons 614a and 616a to increase the access payment multipliers associated with access of the bid side and the ask side, respectively. By clicking the “up” access payment update buttons 614a and 616a the value of the access payment multiplier increases so that, for example, a positive access payment multiplier will go from +1 to +2 and a negative number will go from −2 to −1. Alternatively, a user may click the “down” access payment update buttons 614b and 616b to decrease the access payment multipliers associated with securities for selected bid sides or ask sides. By clicking the “down” access payment update buttons 614b and 616b the value of the access payment multiplier decreases so that, for example, positive number goes from +2 to +1 and a negative number goes from −1 to −2. If the access payment is either −1 or +1 and the user clicks either of the “down” access payment update buttons 614b and 616b, the access payment is reduced to zero. In this case, the arrows on the access payment update buttons 614a, 614b, 616a, and 616b turn black and are disabled.

Once the user has reached a desired access payment multiplier using the access payment update buttons 614a, 614b, 616a, and 616b, the user may select Update button 620 to update the access payment multiplier to reflect the value displayed in update display box 622. By clicking the Update button 618, the user accesses the Update Quote Dialog window 702.

In one embodiment, if the access payment is currently at zero, the access payment multipliers can only be set by using the Add button 620. By clicking the Add button 620, the user accesses the Add Quote Dialog window 802.

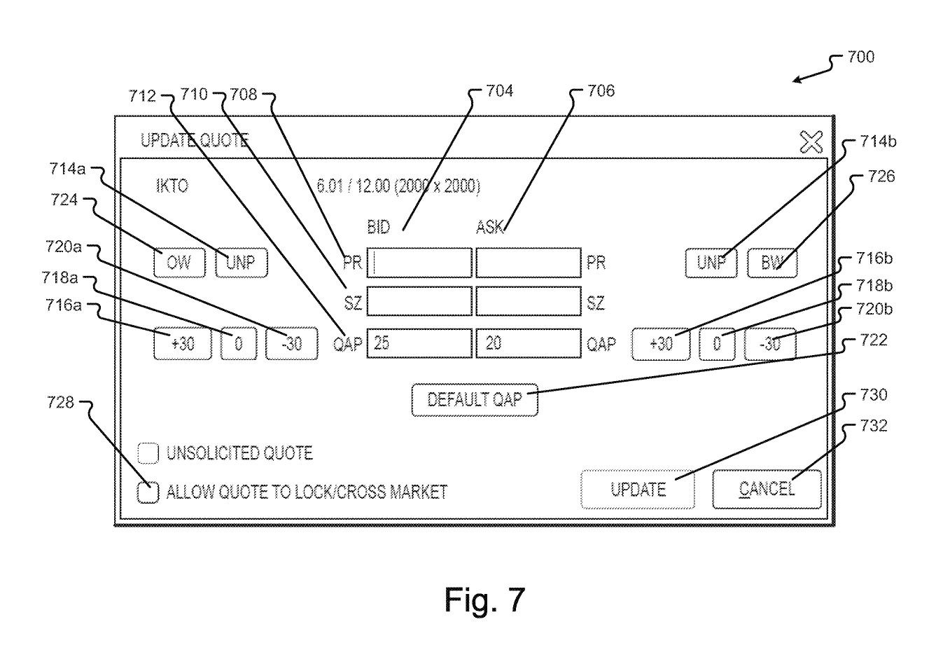

FIG. 7 illustrates an exemplary graphical user interface 700 for updating an access payment multiplier in association with a quote.

According to one embodiment, as displayed in FIG. 7, the graphical user interface 700 may include an Update Quote Dialog window 702 for updating an access payment multiplier for a particular quote. The Update Quote Dialog window 702 may be accessed by clicking the Update button in the Quote Montage window.

Update Quote Dialog window 702 may include a column for BID 704 and a column for ASK 706. Different access payment multipliers may be set depending on whether the bid side or the ask side is accessed. The BID 704 column and the ASK 706 column may include one more rows. These rows may include a price 708 row, a size 710 row, and an access payment 712 row. In one embodiment, upon opening the Update Quote Dialog window 702, the BID 704 column and ASK 706 columns are automatically populated with information specific to the quote. This could include information regarding the price and size of the quote. This could also include a previously set access payment multiplier. If an access payment multiplier has been previously set, the numeric value of that access payment multiplier may automatically populate the access payment 712 row. If a user wants to change the access payment multiplier associated with either a bid side of a trade or an ask side of a trade, the user may enter an updated numeric value into the access payment multiplier 712 row associated with the trade. For example, if the user wishes to enter an updated numeric value of “+27” for a the bid side of a quote, the user may type the value of “+27” into the quote access payment row 712 under the BID 704 column.

Update Quote Dialog window 702 may also include one more Unpriced button 714a and 714b associated with a bid side of a quote and an ask side of a quote. When a user selects an Unpriced button 714a or 714b, the letter “U” will populate in the corresponding price 708 row for the trade and will clear the corresponding size 710 row. For example, if a quote accessed from the bid side is unpriced, selecting Unpriced button 714a will populate Price 708 row of BID 704 column with the letter “U” and clear any value in the size 710 row of BID 704 column.

Update Quote Dialog window 702 may also include one or more access payment multiplier buttons 716a, 718a, 720a, 716b, 718b, and 720b. Selection of any of the access payment multiplier buttons 716a, 718a, 720a, 716b, 718b, and 720b will automatically populate the access payment multiplier 708 row with the specified numeric value. Access payment multiplier buttons 716a and 716b populate the access payment row 712 with an access rebate multiplier maximum for a bid side of a quote and an ask side of a quote, respectively, In other words, the value of +30 is the largest absolute value for a rebate that the Update Quote Dialog window 702 will accept. Access payment multiplier buttons 718a and 718b populate the access payment multiplier 712 row with an access fee multiplier maximum for a bid side of a quote and an ask side of a quote, respectively. In other words, the value of −30 is the largest absolute value for a fee that the Update Quote Dialog window 702 will accept. Access payment multiplier buttons 720a and 720b populate the access payment multiplier 712 row with the value zero for a bid side of a quote and an ask side of a quote, respectively. If an access payment multiplier 712 row is populated with the value “zero” no access payment multiplier will be applied side of the trade associated with the zero populated access payment multiplier 712 row.

Update Quote Dialog window 702 may also include a default access payment multiplier button 722. When a user accesses the default access payment multiplier button 722, the access payment multiplier 712 row for both the BID 704 column and the ASK 706 column will be populated with the default access payment multiplier. As discussed above, the default access payment multiplier is set by the broker-dealer that posts the quote for the security. When the default access payment multiplier button 722 is selected, any previous access payment multipliers for the security will be replaced by the default access payment multiplier set by the broker-dealer.

Update Quote Dialog window 702 may also include an OW (Offer Wanted) button 724 for the bid side of a quote and a BW (Bid Wanted) button 726 for the ask side of a quote. Update Quote Dialog window 702 may also include a lock/cross button 728. When the lock/cross button 728 is selected by a user, the quote locks/crosses across the market. The Update Quote Dialog window 702 may also include an update button 730. When the update button 730 is accessed by the user, the quote update is sent to the EMS for processing. When sent, the EMS stores the price, size, and access payment multipliers as discussed with reference to FIG. 3. If the quote is listed as unpriced, the price and size of the quote are stored as “zero”.

In one embodiment, the access payment multiplier numeric value must be within a specified range. The range corresponds to regulatory compliance. An access payment multiplier within the range, when utilized, would calculate an access payment that complies with regulatory parameters. An access payment multiplier outside the range, when utilized, would calculate an access payment that does not comply with regulatory parameters. An exemplary range is +30 to −30, inclusive. However, this range is one example of a suitable range and could change based on many factors, including but not limited a change in regulatory parameters. If the user enters a numeric value outside of the specified range, that numeric value may be rejected when sent to the EMS. Upon rejection, the user may be notified that the numeric value is outside the acceptable range. Notification may comprise a pop-up box, auditory cue, error message, or any other method of notification known in the art.

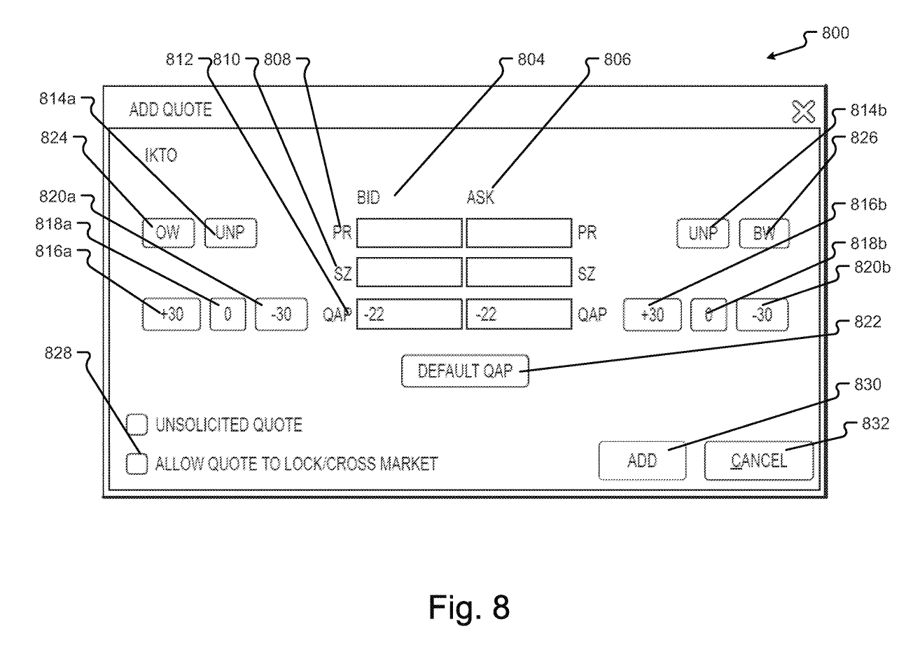

FIG. 8 illustrates an exemplary graphical user interface 800 for adding an access payment multiplier in association with a quote.

According to one embodiment, as displayed in FIG. 8, the graphical user interface 800 may include an Add Quote Dialog window 802 for adding an access payment multiplier for a particular quote. The Add Quote Dialog window 802 may be accessed by clicking the Add button in the Quote Montage window. The Add Quote Dialog window 802 may only be accessed when a security has not previously been associated with an access payment multiplier at the Quote Level.

Add Quote Dialog window 802 may include a column for BID 804 and a column for ASK 806. Different access payment multipliers may be set depending on whether the bid side or the ask side is accessed. The BID 804 column and the ASK 806 column may include one more rows. These rows may include a price 808 row, a size 810 row, and an access payment 812 row. In one embodiment, upon opening the Add Quote Dialog window 802, the BID 804 column and ASK 806 columns are automatically populated with information specific to the quote. This could include information regarding the price and size of the quote. This could also include a previously set access payment multiplier. If an access payment multiplier has been previously set, the numeric value of that access payment multiplier may automatically populate the access payment 812 row If a user wants add an access payment multiplier for associated with either a bid side or an ask side, the user may enter an updated numeric value into the access payment multiplier 812 row associated with the trade. For example, if the user wishes to enter a numeric value of “+27” for a quote accessed from the bid side, the user may type the value of “+27” into the quote access payment row 812 under the BID 804 column.

Add Quote Dialog window 802 may also include one more Unpriced button 814a and 814b associated with a bid side or with an ask side. When a user selects an Unpriced button 814a or 814b, the letter “U” will populate in the corresponding price 808 row for the trade and will clear the corresponding size 810 row. For example, if the bid side of a quote is unpriced, selecting Unpriced button 814a will populate Price 808 row of BID 804 column with the letter “U” and clear any value in the size 810 row of BID 804 column.

Add Quote Dialog window 802 may also include one or more access payment multiplier buttons 816a, 818a, 820a, 816b, 818b, and 820b. Selection of any of the access payment multiplier buttons 816a, 818a, 820a, 816b, 818b, and 820b will automatically populate the access payment multiplier 808 row with the specified numeric value. Access payment multiplier buttons 816a and 816b populate the access payment row 812 with an access rebate multiplier maximum for the bid side of a quote and the ask side of the quote, respectively, In other words, the value of +30 is the largest absolute value for a rebate that the Add Quote Dialog window 802 will accept. Access payment multiplier buttons 818a and 818b populate the access payment multiplier 812 row with an access fee multiplier maximum for a bid side of a quote and an ask side of a quote, respectively. In other words, the value of −30 is the largest absolute value for a fee that the Add Quote Dialog window 802 will accept. Access payment multiplier buttons 820a and 820b populate the access payment multiplier 812 row with the value zero for a bid side of a quote and an ask side of a quote, respectively. If an access payment multiplier 812 row is populated with the value “zero” no access payment multiplier will be applied side of the trade associated with the zero populated access payment multiplier 812 row.

Add Quote Dialog window 802 may also include a default access payment multiplier button 822. When a user accesses the default access payment multiplier button 822, the access payment multiplier 812 row for both the BID 804 column and the ASK 806 column will be populated with the default access payment multiplier. As discussed above, the default access payment multiplier is set by the broker-dealer that posts the quote the security. When the default access payment multiplier button 822 is selected, any previous access payment multipliers for the security will be replaced by the default access payment multiplier set by the broker-dealer.

Add Quote Dialog window 802 may also include an OW (Offer Wanted) button 824 for a bid side of a quote and a BW (Bid Wanted) button 826 for a an ask side of a quote Add Quote Dialog window 802 may also include a lock/cross button 828. When the lock/cross button 828 is selected by a user, the quote locks/crosses across the market. The Add QuoteDialog window 802 may also include an add button 830. When either the lock/cross button 828 or the add button 830 is accessed by the user, the quote addition is sent to the EMS for processing. When sent, the EMS stores the price, size, and access payment multipliers as discussed with reference to FIG. 3. If the quote is listed as unpriced, the price and size of the quote are stored as “zero”.

In one embodiment, the access payment multiplier numeric value must be within a specified range. The range corresponds to regulatory compliance. An access payment multiplier within the range, when utilized, would calculate an access payment that complies with regulatory parameters. An access payment multiplier outside the range, when utilized, would calculate an access payment that does not comply with regulatory parameters. An exemplary range is +30 to −30, inclusive. However, this range is one example of a suitable range and could change based on many factors, including but not limited a change in regulatory parameters. If the user enters a numeric value outside of the specified range, that numeric value may be rejected when sent to the EMS. Upon rejection, the user may be notified that the numeric value is outside the acceptable range. Notification may comprise a pop-up box, auditory cue, error message, or any other method of notification known in the art.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the appended claims.

What is claimed is:

1. A method for displaying, in a graphical user interface, information relating to and facilitating the use of an access multiplier for a security to be traded over an electronic communications network, the method comprising:
dynamically displaying in the graphical user interface a quote montage window having a plurality of sub windows that display a plurality of securities and at least two of the following: a name for each of the securities in the plurality of securities, a price for each of the securities in the plurality of securities, and an associated access payment for the each of the securities;
sorting the displayed plurality of the securities in the quote montage window;
dynamically displaying within the quote montage window, a first sub window including a plurality of bids, wherein the bids are displayed in selectable rows with each row including a broker name, a quote price, and an access payment for the bid associated with the selectable row;
dynamically displaying within the quote montage window, a second sub window including a plurality of asks, wherein the asks are displayed in selectable rows with each row including a broker name, a quote price, and an access payment for the ask associated with the selectable row;
receiving a selection of at least one selectable row within the first sub window;
subsequent to receiving the selection of the at least one selectable row, receiving a selection of the at least one access payment update button;
in response to receiving the selection of the at least one access payment button, displaying a value for an access multiplier in an update display box;
displaying a first update button within the quote montage window;
receiving a selection to the update button;
upon receiving the selection of the update button, displaying an update quote dialog window, wherein displaying the update quote dialog window further comprises displaying within the update quote dialog window:
an ask price input box;
an ask size input box;
an ask access payment input box;
a bid price input box;
a bid size input box;
a bid access payment input box; and
an update button;
populating at least one of the ask price input box, the ask size input box, the ask access payment input box, the bid price input box, the bid size input box, or the bid access payment input box with previously determined information;
receiving an input to at least one of the ask access payment input box or the bid access input box;
receiving a selection of the update button displayed in the update quote dialog window;
updating the at least one of the ask access payment input box or the bid access input box for which input was received; and
removing the update quote dialog window from display.

2. The method of claim 1, wherein each row for the bids also includes a size of a share and a time of an update of the bid corresponding to the row.

3. The method of claim 1, wherein the access payments include values for access rebates, values for access fees, and a null value where no access payment is associated with the particular security.

4. The method of claim 1, wherein displaying the at least one access payment update button further comprises:
displaying a first up access payment update button and a first down access payment update button adjacent to the first sub window; and
displaying a second up access payment update button and a second down access payment update button adjacent to the second sub window.

5. The method of claim 4, wherein receiving a selection of the at least one access payment update button comprises receiving a selection of one of the first up access payment update button, the first down access payment update button, the second up access payment update button, or the second down access payment update button.

6. The method of claim 1, wherein the a first up access payment update button and a first down access payment update button are displayed in green when the associated access payment value is positive.

7. The method of claim 1, further comprising:
displaying an add button within the quote montage window;
receiving a selection of the add button;
in response to receiving the selection of the add button, displaying an add quote dialog window, wherein displaying the add quote dialog window includes displaying within the add quote dialog window a plurality of input boxes for price, size, and access payment values.

8. The method of claim 1, further comprising:
determining that the input to the at least one of the ask access payment input box or the bid access input box is rejected; and
notifying the user that the input has been rejected.

9. A computer-implemented method for displaying, in a graphical user interface, information relating to and facilitating the use of an access multiplier for a security to be traded over an electronic communications network, the method comprising:
dynamically displaying a bid window including a plurality of bids, wherein the bids are displayed in selectable rows with each row including a quote price, an access payment, and an update time for the ask associated with the selectable row; and
dynamically displaying an ask window including a plurality of asks, wherein the asks are displayed in selectable rows with each row including a quote price, an access payment, and an update time for the ask associated with the selectable row.

10. The computer-implemented method of claim 9, wherein the bid window and the ask window are displayed in a quote montage window.

11. The computer-implemented method of claim 9, further comprising receiving a selection of an update button in the quote montage window and, in response to receiving the selection of the update button in the quote montage window, displaying an update quote dialog window having a plurality of options and inputs to update a quote.

12. The computer-implemented method of claim 10, wherein the update quote dialog window includes an ask price input box, an ask size input box, an ask access payment input box, a bid price input box, a bid size input box, and a bid access payment input box.

13. The computer-implemented method of claim 11, further comprising;
displaying within the update quote dialog window a default access payment multiplier button;
receiving a selection of the default access payment multiplier button; and
in response to receiving the selection of the default access payment multiplier button, populating both the ask access payment input box and the bid access payment input box.

14. The computer-implemented method of claim 9, further comprising receiving a selection of an add button in the quote montage window and, in response to receiving the selection of the update button in the quote montage window, displaying an add quote dialog window, wherein displaying the add quote dialog window includes displaying within the add quote dialog window a plurality of input boxes for price, size, and access payment values.

15. The computer-implemented method of claim 14, further comprising displaying within the add quote dialog window an offer wanted button and a bid wanted button.

16. The computer-implemented method of claim 14, further comprising displaying within the add quote dialog window access payment multiplier buttons that include at least a minimum access payment multiplier button and a maximum access payment multiplier button.

17. The computer-implemented method of claim 9, wherein each row for the bids also includes a size of a share and a broker name.

18. A computer-implemented system for providing an access payment in association with a security, the system comprising:
a processor;
a memory communicatively coupled to the processor, the memory storing information for providing the access payment in association with the security and having computer-executable instructions that when executed by the processor, provide:
a quoting engine, wherein the quoting engine is communicatively coupled to a database for storing access payment multipliers; and
a trade messaging engine, wherein the trade messaging engine is configured to receive a request for a trade from a trader application over the Internet and upon receipt of the request, calculate an access payment from an access payment multiplier and quote tick size associated with the security, and to transmit over the Internet the access payment multiplier and quote tick size to the trader application, wherein the transmit causes the trader application to display the access payment in association with the trade for the security.

19. The computer-implemented system of claim 18, wherein the quoting engine is further configured to receive an update of an access payment multiplier from a graphical user interface.

20. The computer-implemented system of claim 18, wherein the quoting engine is further configured to receive an addition of an access payment multiplier from a graphical user interface.
